(19) United States
(12) Patent Application Publication
(10) Pub. No.: US 2014/0294526 A1
(43) Pub. Date: Oct. 2, 2014

(54) METHOD FOR PRODUCING A THREAD IN A WORKPIECE

(71) Applicant: Peter Kopton, Kosching (DE)

(72) Inventor: Peter Kopton, Kosching (DE)

(73) Assignee: AUDI AG, 85045 Ingolstadt (DE)

(21) Appl. No.: 13/993,971

(22) PCT Filed: Dec. 9, 2011
(86) PCT No.: PCT/EP11/06194

§ 371 Date: Sep. 3, 2013

(30) Foreign Application Priority Data
Dec. 14, 2010 (DE) 10 2010 054 476.0

(51) Int. Cl. B23G 1/16; B23G 1/32

(52) U.S. Cl. CPC B23G 1/16; B23G 1/32
USPC 408/1 R; 409/66

(57) ABSTRACT

A method for producing a thread in a workpiece comprises the following process steps: a) producing a wall of the workpiece, wherein the wall has a number n of grooves greater than or equal to 1 encompassing a thread axis, b) introducing a corresponding thread-producing region of a thread-producing tool into each of the grooves, c) producing a thread in each subregion, adjoining the groove(s) of the wall of the workpiece by rotating the thread-producing tool about the thread axis, wherein, following rotation, each thread-producing region projects into the same groove again or into another groove in the wall, and d) moving each thread-producing region of the thread-producing tool out of the associated groove in the direction along the groove.

The invention relates to a method for producing a thread in a workpiece.

Both chip-producing and chip-less methods and threading tools for producing a thread or post-machining a thread are known in the art. Producing a thread by cutting is based on removal of the material of the workpiece in the region of the thread. Producing a thread without cutting is based on forming the workpiece and producing the thread in the workpiece by applying pressure. The Handbuch der Gewindetechnik and Frästechnik (Manual of Threading and Milling Technique), Publisher: EMUGE FRANKEN, Publishing Company: Publicis Corporate Publishing, Release Year: 2004 (ISBN 3-89578-232-7), hereinafter referred to only as “EMUGE Manual”, gives an overview over the employed thread-producing tools and processes.

Producing a thread by machining or cutting also includes taps (see EMUGE Manual, chapter 8, pages 181-298), and thread milling cutters (see EMUGE Manual, chapter 10, pages 325-372) and, only for external threads, dies (see EMUGE Manual, chapter 11, pages 373 to 404).

A tap is a thread cutting tool having cutting edges or thread cutting teeth arranged along an outer thread with the thread pitch of the thread to be produced. When producing the thread, the tap is moved axially into a cylindrical core hole in a workpiece with an axial feed rate and by rotating about its tool axis with a rotation speed commensurate with the pitch-dependent feed rate, wherein the tool axis of the tap is aligned coaxially in relation to the center axis of the core hole and its cutting edges are in permanent engagement with the workpiece at the core hole wall (continuous cut), thereby producing a continuous thread on the core hole wall.

The so-called thread-forming taps belong to the chip-less thread-producing tools (see EMUGE Manual, chapter 9, pages 299-324) and, only for external threads, the thread-rolling tools (see EMUGE Manual, chapter 11, pages 373 to 404).

Thread-forming taps are tapping tools with an approximately spiral or helical circumferential thread profile, along which a plurality of pressing lands (also known as form teeth, forming teeth or shaped wedges) are arranged, which are formed by offset, outwardly extending, and generally rounded polygonal corner regions of an approximately polygonal cross section of the thread-forming tap. When producing the thread, the thread-forming tap, like the cutting tap, is moved into a cylindrical core hole in a workpiece with an axial advance with respect to the tool axis and with a rotation about its tool axis, wherein the tool axis of the tap is coaxially aligned with the central axis of the core hole. The rotation speed and the axial feed rate are coordinated commensurate with the thread pitch. The pressing lands of the thread-forming tap are in permanent engagement with the workpiece at the core hole wall and press the thread into the core hole wall through plastic deformation, thereby producing a continuous thread on the core hole wall.

Furthermore, combination tools from drill and thread milling cutters are known that operate exclusively by chip-removing machining, namely the so-called thread milling cutter (BGF) (see EMUGE Manual, chapter 10, page 354) and the so-called circular thread milling cutter (ZBGF) (see EMUGE Manual, chapter 10, page 355), with which initially the core hole for the thread and subsequently the thread in the core hole can be produced.

The tool shank of the aforementioned thread-producing tools is typically at least approximately cylindrical about its longitudinal axis and/or is received and retained in the chuck of a machine tool at its end facing away from the workpiece. The screws or threads screwed into the produced internal threads include continuous helical exterior threads complementary to the internal threads.

It is an object of the invention to provide a novel process for producing a thread, in particular for producing an internal thread.

This object is attained with the features of claim 1. Advantageous embodiments and further developments of the method according to the invention are recited in the claims dependent from claim 1.

The method for producing a thread in a workpiece according to claim 1 includes the following process steps:
a) generating a number n≧1 of grooves in a peripheral wall of the workpiece encompassing a thread axis, or
b) generating a wall of the workpiece having a number n≧1 of grooves and encompassing a thread axis,
c) inserting a respective thread-producing region of a thread-producing tool in each of the grooves in the wall of the workpiece in a direction along the corresponding groove, wherein the thread-producing region extends into the associated groove in a radial direction with respect to the thread axis, while maintaining a radial distance (Δr) to the groove bottom,
d) forming a thread in each of the partial wall regions of the wall of the workpiece adjacent to the groove(s) by rotating the thread-producing tool by a predetermined angle about the rotation axis and simultaneously advancing the thread-producing tool coaxial with the thread axis with an axial feed rate commensurate with the rotation speed of the rotational movement and the thread pitch, wherein during the rotation and the simultaneous axial advance each thread-producing region engages in the corresponding partial wall section and generates a corresponding part of a thread and projects after the rotation again into the same groove or into a different groove in the wall,
e) moving each thread-producing region of the thread-producing tool out of the associated groove in the direction along the groove.

An advantage of this method according to the invention compared to conventional thread-cutting or thread-producing processes is that the thread-producing tool is not required to have a starting cone or chamfer area normally present at taps or forming taps, wherein the maximum radial spacing of the thread teeth or pressing lands increases along a conical surface from the end of the tap or forming tap. As a result, a complete thread along a greater length of thread can be produced even in a blind hole, since the incomplete thread which would occur over the length of the chamfer area or the starting cone is eliminated. Furthermore, the thread-producing tools can be made shorter, which has a positive effect besides other advantages, in particular, also at small working heights.

With the method according to the invention, compared to the prior art methods, the threading tool can be very quickly moved to its working position against the wall of the workpiece due to the (exclusively) axial insertion movement, whereafter the thread can be manufactured with a substantially smaller rotation angle or with substantially fewer turns, and finally after the thread is formed, the threading tool can be removed outwardly and away from the wall of the workpiece due to the (exclusively) axial withdrawal movement. When tapping or producing a thread according to the prior art, several turns of the tap or thread former are always required, first when rotating the tool in and then when rotating the tool back out again. With the method according to the invention, a single revolution, or even a fraction of a revolution corresponding to the number and arrangement of the grooves, in combination with axial feeding and withdrawal movements, is sufficient. The time required for generating the additional grooves is typically less than the time saved when producing the threads.

Furthermore, the thread according to the invention can be introduced at a precise location with respect to its axial position and with respect to the start of the thread. The grooves represent defined positions for the thread.

In a preferred embodiment, the rotation angle for rotating the thread-producing tool is selected so as to correspond to the angular distance between two directly adjacent grooves and/or so that each thread-producing region projects after the rotation into a groove which is directly adjacent to the groove into which the thread-producing region projected before the rotation. In particular, the n grooves are formed with an identical mutual angular spacing of 360°/n and the rotation angle is 360°/n, or 720°/n or 1080°/n.

The groove(s) extend(s) substantially axially and/or parallel to the thread axis.

Preferably, each groove is formed by machining, in particular with a broaching tool or a planing tool, such as a broach or a groove cutter moving in the direction of the groove.

In a first variant, at least one thread-producing region is a thread-forming region, and generates its part of the thread by forming and thus chip-less. In particular, at least a portion of the thread-producing regions has thread pressing lands disposed on a helix corresponding to the thread pitch about the tool axis, wherein the thread pressing lands project radially farthest outward within the thread-producing region.

In a second variant that can also be combined with the first variant, at least one thread-producing region is a thread-cutting region and generates its part of the thread by machining. In particular, at least a part of the thread-producing regions has thread-cutting teeth arranged on a helix disposed about the tool axis and having a thread pitch corresponding to the thread to be produced, wherein the thread cutting edges project radially farthest outward within the thread-producing region. Preferably, outer open surfaces generally extending in the opposite direction of the cutting direction or of the rotation direction are arranged following the thread-cutting teeth.

The thread-producing regions of the thread-producing tool generally project radially farther outward than the other outer surfaces of the thread-producing tool.

The wall of the workpiece, in which the thread is formed, is preferably a core hole wall of a core hole, in particular a blind hole or a through-hole in the workpiece, so that the thread is an internal thread. However, it is also possible to produce an external thread on an outer wall of the workpiece.

The invention will be described below with reference to exemplary embodiments. Reference is also made to the drawing, in which shows schematically in

FIG. 1 a core hole in a workpiece in a sectional view,

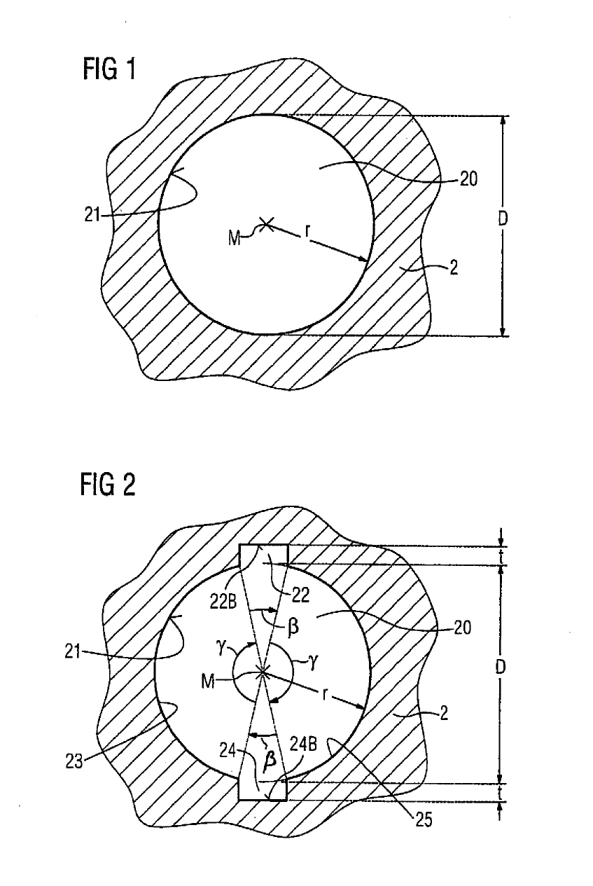

FIG. 2 the core hole as shown in FIG. 1 with two grooves generated in a first process step, in a sectional view,

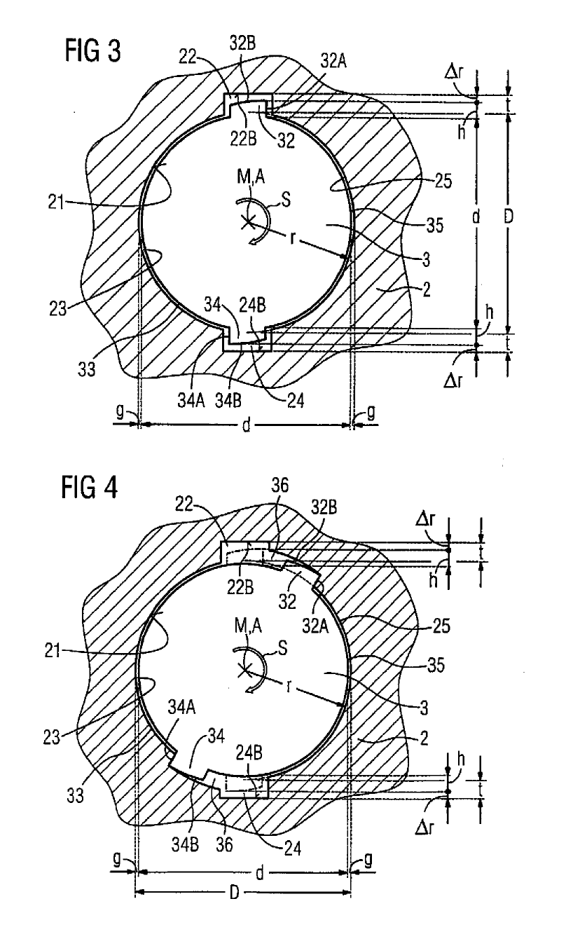

FIG. 3 the core hole as shown in FIG. 2 with a thread-producing tool introduced in a second process step, with two thread-producing regions located in the grooves, in a sectional view,

FIG. 4 the core hole as shown in FIG. 3 with an inserted thread-producing tool, which is rotated in a third process step by a rotation angle and moved with an axial advance, wherein the thread-producing regions have produced a part of a thread, in a partial sectional view,

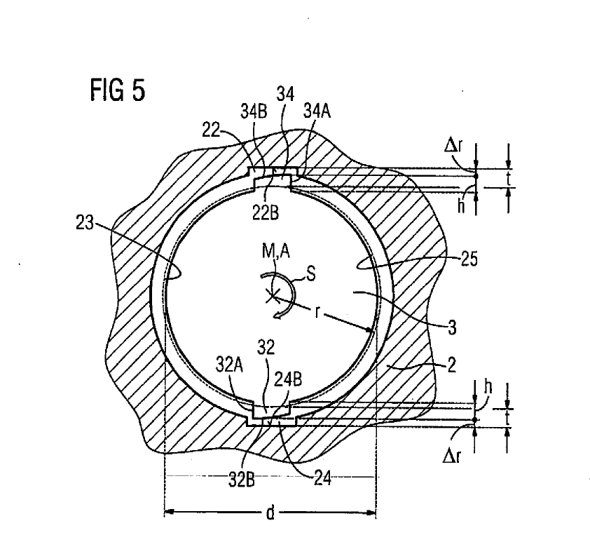

FIG. 5 the core hole as shown in FIGS. 3 and 5 with an inserted thread-producing tool, which was rotated in the third process step by the full angle of rotation and moved with an axial advance, wherein the thread-producing regions have produced the complete thread, in a partial cross-sectional view,

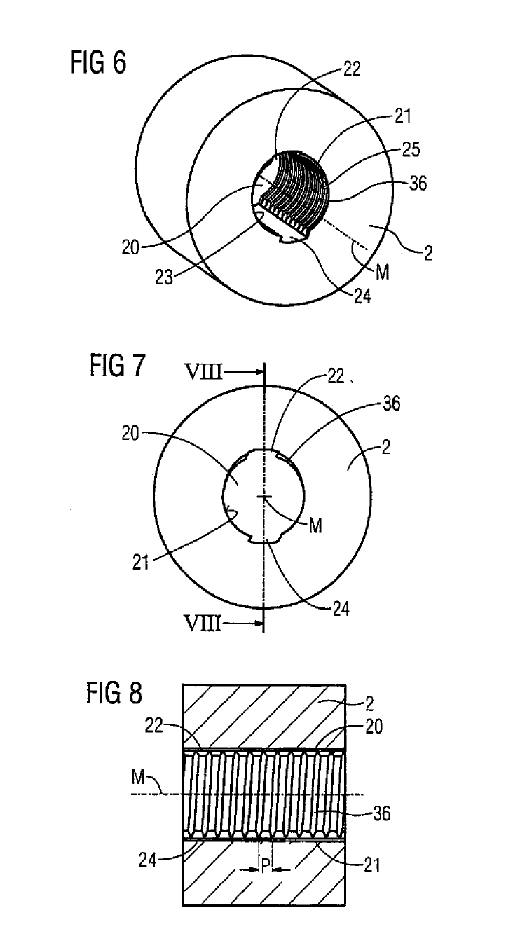

FIG. 6 a workpiece with a core hole with two grooves and a complete thread between the grooves in a perspective view,

FIG. 7 the core hole as shown in FIG. 6 in a plan view, and

FIG. 8 the core hole as shown in FIG. 7 is a sectional view taken along the line VIII-VIII in FIG. 7.

Corresponding parts and quantities in FIGS. 1 to 8 have the same reference symbols.

FIG. 1 shows a core hole 20 in a workpiece 2 in cross-section, wherein the core hole 20 has a cylindrical core hole wall 21 with the diameter D encompassing a center axis M. The radial direction with respect to the central axis M is denoted with an arrow and the reference symbol r. The core hole 20 is preferably formed by machining, particularly with a drilling tool or a milling tool.

In accordance with FIG. 2, two mutually parallel axial grooves 22 and 24, which are formed and arranged in the core hole wall 21 parallel to and on diametrically opposed sides of the central axis M, in particular with a mutual offset of 180°. The depths of the grooves 22 and 24 measured from the outer diameter or from the original cylindrical core hole wall 21 of the core hole 20 are denoted by t, wherein the two grooves 22 and 24 are preferably identical. The radially outer groove bottom of the groove 22 is designated with 22B and corresponding groove bottom of the groove 24 with 24B. A partial wall section of the core hole wall 21 extending counterclockwise between the grooves 22 and 24 in FIG. 2 is designated with 23, and a partial wall section located on the other side between the grooves 22 and 24 is designated with 25.

The angular portion β of a groove 22 or 24 corresponding to the peripheral portion at the total circumference of the core hole 20 and its core hole wall of 360° is between 2% and 12.5%, preferably between 7.5% and 10%, or expressed in degrees, between 7.2° and 45°, preferably between 27° and 36°. With a cutting thread-producing tool, such as a tap, the angular portion β of the grooves 22 may also be smaller than with a forming or furrowing thread-producing tool, such as a thread-forming tap. The angular portion γ corresponding to the remaining peripheral portion of each partial wall section 23 and 25 is then (360°−2β)/2=180°−β.

The grooves 22 and 24 can be machined, in particular with a broach or a milling tool.

Basically, the core hole 20 can also be formed together with the grooves 22 and 24 in a single process step, in particular by chip-cutting, for example with a milling tool.

In accordance with FIG. 3, a thread-producing tool 3 which is rotatable about its tool axis A is now inserted into the core hole 20, with the tool axis A being coaxial with respect to the center axis M of the core hole 20. The thread producing tool 3 has two thread-producing regions 32 and 34, which are diametrically opposed relative to the tool axis A or mutually offset by 180°, and two in particular cylindrical outer surfaces 33 and 35 arranged between the thread-producing regions 32 and 34.

The thread-producing regions 32 and 34 project radially farther outward than the outer surfaces 33 and 35. The diameter of the thread-producing tool 3 from the outer surface 33 to the outer surface 35 is denoted with d. The thread-producing regions 32 and 34 have thread-cutting teeth 32A and 34A disposed on a spiral or helix about the tool axis A with a thread pitch corresponding the thread to be produced (of which only one can be seen in cross-section in FIG. 2) and outer free surfaces 32B and 34B adjacent to the thread-cutting teeth 32A and 34A. In FIG. 2, the thread-cutting teeth 32A and 34A are arranged at the front, as seen in a rotation direction S about the tool axis A, whereas the free surfaces 32B and 34B extend to the rear from the respective thread cutting teeth 32A and 34A. The thread-cutting teeth 32A and 34A are the radially farthest outwardly projecting portions of the thread-producing regions 32 and 34 of the thread-producing tool 3. The radial height of the thread cutting tooth 32A or 34A in relation to the remaining outer periphery of the thread-producing tool 3, i.e. in particular in relation to the outer surfaces 33 and 35, is designated with h, and is preferably identical for the two thread-producing regions areas 32 and 34.

The radial distance of the thread-cutting teeth 32A and 34A from the respective groove bottom 22B and 24B of the respective groove 22 or 24 is designated with Δr and is preferably also identical for both grooves 22 and 24.

This radial distance Δr is typically selected to be between ⅓ and ½ of the groove depth t.

The thread-producing portion 32 projects in the radial direction r into the groove 22, whereas the thread-producing portion 34 projects into the groove 24. Accordingly, d<D and d/2+h<D/2+t holds for the respective dimensions.

The radial distance or the gap width between the partial wall section 23 of core hole wall 21 and the facing outer surface 33 of the thread-producing tool 3 as well as between the partial wall section 25 of core hole wall 21 and the facing outer surface 35 of the tool 3 is designated with g and corresponds to g=(D−d)/2. This gap width g and the radial distance Δr between free surface 32B or 34B and groove bottom 22B and 24B, respectively, are shown enlarged to improve clarity of the illustration. As a rule, the clearance between the thread-producing tool 3, on one hand, and the core hole wall 21 of the core hole 20 or the grooves 22 and 24, on the other hand, will have smaller dimensions. Preferably, 0.01<g/D<0.1; however, other parameter ratios may also be selected.

FIG. 4 now shows the thread-producing tool 3 after rotation in the core hole 20 of the workpiece 2 in the rotation direction S by an angle α relative to the position shown in FIG. 3.

In addition to the rotary movement in the rotation direction S, the thread-producing tool 3 is moved inwardly into the core hole 20 with an axial or linear feed movement coaxially with the tool axis A and also coaxially with the center axis M, which is not visible in the sectional view of FIG. 4.

The feed rate of axial advance is matched to the rotation speed of the rotary movement in the rotation direction S and the desired thread pitch P, so that during the same time, in which the tool 3 makes a full revolution or rotates about a rotation angle α=360°, the axial feed or axial advance corresponds exactly to the thread pitch P. Thus, the axial feed rate is the product of the thread pitch P and the rotation frequency of the tool 3.

With the rotary movement about the rotation angle α of the thread-producing tool 3 with simultaneous axial feed movement of a distance P=α/360°, a portion of the thread 36 of the thread was produced in the core hole wall 21 of the core hole 20, starting from the groove 22 in the partial wall section 25, and starting from the groove 24 in the partial wall section 23. This is illustrated in FIG. 4 which shows the entire partial region produced so far in one revolution of the produced thread 36.

The thread-producing tool 3 has now axially in relation to its tool axis A in each of the thread-producing regions 32 and 34 a corresponding axial row of thread cutting teeth 32A and 34A, which are axially offset from one another.

Depending on the number of these thread cutting teeth 32A and 34A in the respective row, during half a revolution by α=180° of the thread-producing tool 3 and simultaneous advance by P/2, a number of thread revolutions of the thread 36 corresponding to the number of thread-cutting teeth arranged in an axial row is produced, which are each interrupted by the grooves 22 and 24. The diametrically opposed thread-cutting teeth 32A and 34A are hereby each arranged with an offset of P/2, so that the two separately produced half revolutions of the thread 36 in the wall section 23 and in the wall section 25 then transition into each other after the groove 22 and 24 along the desired course of the thread in the helix with the thread pitch P.

The radial height h of the thread cutting tooth 32A or 34A determines the distance between the thread root 36B of the thread 36 from the core hole wall 21.

One rotation of the tool 3 about the distance angle between the grooves 22 and 24 in the core hole 20, which is equal to 180° in the example of FIGS. 2 to 4, as total rotation angle α hereby covers in the entire intermediate partial wall sections 23 and 25, thereby producing the complete thread 36 in the partial wall sections 23 and 25.

The situation after half a revolution is shown in FIG. 5.

The thread-producing region 32 which previously projected into the groove 22 now projects in the diametrically opposed groove 24 and the thread-producing region 34 which previously projected into the groove 24 now projects into the groove 22, both with the radial distance or from the groove bottom 24B and 22B, respectively.

The thread-producing tool 3 can then be withdrawn from the core hole 20 axially in relation to the central axis M in a further process step, since the thread-producing regions 32 and 34 can be moved axially outwardly along the grooves 24 and 22 without damaging of the produced thread 36.

In general, with a number n>2 of grooves and with an equidistant or uniform pitch of the grooves in the core hole wall 21, i.e., a separation angle of 360°/n, a rotation of 360°/n is sufficient for producing one complete thread pitch between the grooves and removing the tool from the core hole.

With a non-equidistant arrangement or non-uniform pitch of the grooves, a complete revolution about 360° is generally necessary for moving the thread-producing regions back into the grooves and withdrawing the tool from the core hole, unless there is an axis of symmetry or an n-fold rotational symmetry where each thread-producing region again projects into an associated groove already at a smaller rotation angle.

With this method, the thread-producing tool 3, which is ultimately a modified tap, need not have a starting cone or chamfered region in which the maximum radial spacing of the thread-cutting teeth increases along a conical surface from the end of the tap, in order to attain a corresponding increase of the chip and the penetration depth of the thread cutting teeth into the workpiece surface without letting the cutting pressure to become too high.

With the thread-producing tool 3 according to the invention, which engages with its thread-producing regions 32 and 34 in the already produced grooves 22 and 24, the thread can instead be produced with the full thread profile depth commensurate with the radial height h of the thread cutting tough 32A and 34A, and as viewed along the axial thread length of the thread; even when this core hole 20 is implemented as a blind hole, no subregion is lost in an incomplete thread which would otherwise be caused by the initial cut or starting cone with conventional taps. With the method of the invention, the thread 36 produced with a rotation of only 180° is therefore complete over its entire axial thread length. This is an advantage which can more than compensate for certain disadvantages in the strength caused by the interruptions of the thread 36 in the region of the two grooves 22 and 24.

Moreover, in spite of the additional step for producing the grooves 22 and 24, the thread-producing process itself can be performed in a shorter time than when using conventional taps in a circular core hole without grooves 22 and 24.

Furthermore, coolants and/or lubricants, in particular in the form of oil or oil aerosol, can be transported or guided via the grooves 22 and 24 to the location where the thread is formed and can also be used for removing chips. Furthermore, at least the last-produced chips can be introduced by the cutting tooth into the respective groove 22 or 24 and removed therefrom with a comparatively large volume of the coolant and/or lubricant.

For the transport of coolant and/or lubricant to or from the thread-producing regions 32 and 34 and/or for the removal of chips from machined thread-producing regions 32 and 34, the thread-producing tool 3 may also include unillustrated outer grooves and/or internal passages extending on or to the thread-producing regions 32 and 34.

The core hole 20 in FIGS. 1 through 5 can be a through-hole as well as a blind hole. The wall of the workpiece can thus be, as illustrated, the inner wall of a through-hole or a non-continuous hole in the workpiece for producing an internal thread. However, the method may also be used for producing an external thread, wherein the grooves and subsequently the thread in the outer wall of a shaft or a bolt or the like are produced, and wherein the thread-producing regions of the thread-producing tool are arranged accordingly on an inner surface or project inwardly and engage the outer wall of the workpiece from the outside. The diameter of the thread-producing tool is then larger in than the diameter of the wall of the workpiece, whereas it is smaller for an internal thread.

FIGS. 6 to 8 show a thread formed with the method according to the invention in a through-hole as the core hole 20, with the thread-producing tool 3 already removed.

The thread 36 is fully formed in the partial wall sections 23 and 25 of the core hole wall 21 of the core hole 20 and is interrupted only in the region of the grooves 22 and 24. The central axis M of the core hole 20 is now the thread axis of the produced thread with the (interrupted) thread 36. FIG. 8 also shows the pitch P of the thread 36.

In an unillustrated embodiment, a modified forming tap may be used as thread-producing tool instead of a modified tap shown in FIGS. 3 to 5, wherein the thread-producing portions have radially outwardly projecting pressing lands or forming teeth instead of thread cutting teeth, wherein the pressing lands or forming teeth produce the thread chip-less with an otherwise identical rotation and simultaneous feed movement of the thread-producing tool by way of a plastic deformation in the core hole wall 21. The pressing lands may be arranged in particular in the middle of the thread-producing regions, again at a radial distance from the respective groove base of the grooves.

Preferred materials of the workpiece are metals, in particular aluminum alloys and magnesium alloys and other light metals; however, the invention is not limited to these materials. Moreover, suitable workpieces are thick-walled or solid workpieces, but also thin-walled parts or metal sheets, in particular made of steel or other materials.

### LIST OF REFERENCE SYMBOLS

2 workpiece
3 thread-producing tool
20 core hole
21 core hole wall
22, 24 groove
22B, 24B groove base
23, 25 wall region
32, 34 thread-producing region
32A, 34A thread-cutting tooth
32B, 34B free surfaces
33, 35 outer surface
36 Thread
A tool axis
D core hole diameter
d tool diameter
g gap width
S rotation direction
M central axis
P thread pitch
t groove depth
r radius
h radial height
Δr radial distance
α rotation angle
β, γ angular portion

1-8. (canceled)

9. A method for producing a thread in a workpiece, comprising:
generating one or more grooves in a wall of the workpiece surrounding a thread axis, or generating a wall of the workpiece having one or more grooves surrounding the thread axis,
inserting a thread-producing region of a thread-producing tool in a corresponding groove in a direction aligned with the corresponding groove, wherein the thread-producing region projects into the corresponding groove in a radial direction with respect to the thread axis while maintaining a radial distance to a groove bottom,
producing a thread in each partial wall section adjacent to the one or more grooves by rotating the thread-producing tool about the thread axis by a predetermined rotation angle and by simultaneously axially advancing the thread-producing tool coaxially with the thread axis with an axial feed rate that matches a rotation speed of the thread-producing tool and a thread pitch, wherein during the rotation and the simultaneous axial advance each thread-producing region engages in a corresponding partial wall section and produces a corresponding part of a thread, with the thread-producing region projecting after the rotation again into the same groove as before the rotation or into another groove, and
withdrawing the thread-producing region of the thread-producing tool from the corresponding groove in the direction aligned with the corresponding groove.

10. The method of claim 9, with at least one of the following features:
the rotation angle corresponds to an angular distance between two directly adjacent grooves,
the rotation angle is selected so that each thread-producing region, after the rotation, projects into a groove directly adjacent to the groove into which the thread-producing region projected before the rotation, and
the n grooves are produced with an identical mutual angular spacing of 360°/n, with the rotation angle being 360°/n, 720°/n or 1080°/n, wherein n is a number of grooves.

11. The method of claim 9, wherein each groove is formed as an axial groove extending substantially parallel to the thread axis.

12. The method of claim 11, wherein each groove is formed by machining.

13. The method of claim 11, wherein each groove is machined with a broaching or planing tool moving in a direction of the groove.

14. The method of claim 11, wherein each groove is machined with a milling cutter.

15. The method of claim 11, wherein each groove is machined with a groove cutter.

16. The method of claim 11, with at least one of the following features:
at least one thread-producing region is a thread-forming region producing its part of the thread by chip-less forming, and
at least a part of a thread-producing region has thread pressing lands arranged on a helix about the tool axis corresponding to the thread pitch of the thread to be produced, with the thread pressing lands projecting radially farthest outwardly within the thread-producing region.

17. The method of claim 11, with at least one of the following features:
at least one thread-producing region is a thread cutting region producing its part of the thread by machining, and
at least a part of a thread-producing region has thread-cutting teeth arranged on a helix about the tool axis with the thread pitch corresponding to the thread to be produced, with the thread-cutting teeth projecting radially farthest outward within the thread-producing region, wherein preferably outer free surfaces are connected to the thread-cutting teeth in a direction opposing a cutting direction or a rotation direction.

18. The method of claim 11, wherein the thread-producing region projects radially farther outward than another outer surface of the thread-producing tool.

19. The method of claim 11, wherein the wall of the workpiece, in which the thread is produced, is a core hole wall of a core hole in the workpiece.

20. The method of claim 19, wherein the core hole is a blind hole or a through-hole.

21. The method according to claim 19, wherein the wall of the workpiece and the one or more grooves in the wall are produced in a common processing step or with a common processing tool.

22. The method according to claim 21, wherein the common processing tool is a milling cutter.
